(19) United States
(12) Patent Application Publication
(10) Pub. No.: US 2014/0122697 A1
(43) Pub. Date: May 1, 2014

(54) PROVIDING CONTENT TO LINKED DEVICES ASSOCIATED WITH A USER

(71) Applicant: Google Inc., (US)

(72) Inventors: Yifang Liu, Redwood City, CA (US); Roberto J. Bayardo, JR., San Jose, CA (US); Guangyu Zhu, Redwood City, CA (US)

(73) Assignee: Google Inc., Mountain View, CA (US)

(21) Appl. No.: 13/666,391

(22) Filed: Nov. 1, 2012

(51) Int. Cl. G06F 15/173

(52) U.S. Cl. 709/224

(57) ABSTRACT

Methods, systems, and apparatus, including computer programs encoded on a computer-readable storage medium, and including a method for selecting content. The method comprises identifying historical data including a log of entries, each entry including a user identifier associated with a given user that accessed a service, a service identifier associated with the service, and a device identifier associated with a device used by the user for accessing the service. The method further comprises evaluating log entries including identifying pairs of log entries that include a same user identifier and a same service identifier but different device identifiers. The method further comprises linking plural devices to a user associated with the same user identifier based on the evaluating when a given device is determined to be likely to be personal to the user, and using historical information associated with the linked devices to select content for delivery to the user.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can then be provided to the user or user device based on the received request. Some users may use multiple devices to access content.

### SUMMARY

In general, one innovative aspect of the subject matter described in this specification can be implemented in methods that include a computer-implemented method for selecting content. The method comprises identifying historical data including a log of entries, each entry including a user identifier associated with a given user that accessed a service, a service identifier associated with the service, and a device identifier associated with a device used by the user for accessing the service. The method further comprises evaluating log entries including identifying pairs of log entries that include a same user identifier and a same service identifier but different device identifiers. The method further comprises linking plural devices to a user associated with the same user identifier based on the evaluating when a given device is determined to be likely to be personal to the user. The method further comprises using historical information associated with the linked devices to select content for delivery to the user.

These and other implementations can each optionally include one or more of the following features. The method can further comprise: identifying a first device associated with the user, identifying other user identifiers associated with the user when using the first device including evaluating the historical data to determine one or more other user identifiers for users that have accessed other services that are associated with the first device, linking the identified other user identifiers to the user, and using the linked other user identifiers to select content for delivery to the user. The linking can include determining a likelihood that the given device is personal to the user. Determining a likelihood can include determining a likelihood that the given device is shared by plural users. Determining a likelihood can include evaluating activities associated with the given device using the historical data. Determining a likelihood can include identifying a threshold and determining if the likelihood exceeds the identified threshold. The method can further comprise gathering information about how the user accesses services including storing, in a log of historical data, user accesses along with access device data. Gathering information can further include monitoring user interactions with services as part of an access control process. The access control process can execute in a cloud computing environment. Using the historical information associated with linked devices can further include using the historical information to select advertisements for delivery to the user.

In general, another innovative aspect of the subject matter described in this specification can be implemented in computer program products that include a computer program product tangibly embodied in a computer-readable storage device and comprising instructions. The instructions, when executed by a processor, cause the processor to: identify historical data including a log of entries, each entry including a user identifier associated with a given user that accessed a service, a service identifier associated with the service, and a device identifier associated with a device used by the user for accessing the service; evaluate log entries including identifying pairs of log entries that include a same user identifier and a same service identifier but different device identifiers; link plural devices to a user associated with the same user identifier based on the evaluating when a given device is determined to be likely to be personal to the user; and use historical information associated with the linked devices to select content for delivery to the user.

In general, another innovative aspect of the subject matter described in this specification can be implemented in systems that include a system for selecting content, the system comprising a processor and a memory including instructions that when executed cause the processor to: identify historical data including a log of entries, each entry including a user identifier associated with a given user that accessed a service, a service identifier associated with the service, and a device identifier associated with a device used by the user for accessing the service; evaluate log entries including identifying pairs of log entries that include a same user identifier and a same service identifier but different device identifiers; link plural devices to a user associated with the same user identifier based on the evaluating when a given device is determined to be likely to be personal to the user; and use historical information associated with the linked devices to select content for delivery to the user.

Particular implementations may realize none, one or more of the following advantages. Evaluating different indicators (e.g., user account activities, device type, user habits, and social network traffic) and probability data associated with each can provide improved accuracy for deciding whether to link devices associated with a given user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A shows an example sequence of events in a system for selecting content based in part on linked devices associated with a user.

FIG. 2B shows an example sequence of events in the system for linking and selecting content for additional devices associated with the user.

FIG. 3A is a flowchart of an example process for selecting content based at least in part on devices linked using historical data related to user access of specific services from specific devices.

FIG. 3B is a flowchart of an example process for selecting content based at least in part on additional user identifiers associated with the user.

FIG. 3C shows an example system for modeling multiple users on one device.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for logically linking user devices so that activities on one device associated with a user can be used to influence the selection of content (e.g., advertisements) to be presented on a different device associated with the same user. The linking can be performed based at least in part on device types of the devices (e.g., mobile vs. non-mobile) and historical information, e.g., including information about activities detected when the user is logged into various services from each of the different respective devices. Deciding to link or not can depend on probability data (e.g. likelihood that a given device is unique to a user (and not shared)). Linking can take advantage of cloud-based user account management (CUAM) technology so that personally identifiable information (PII) is not required to be stored to link the devices. In some implementations, users may be provided with an opportunity to enable/disable or otherwise control programs or features that allow the user to be discovered across multiple devices and/or to be provided content based on the discovery.

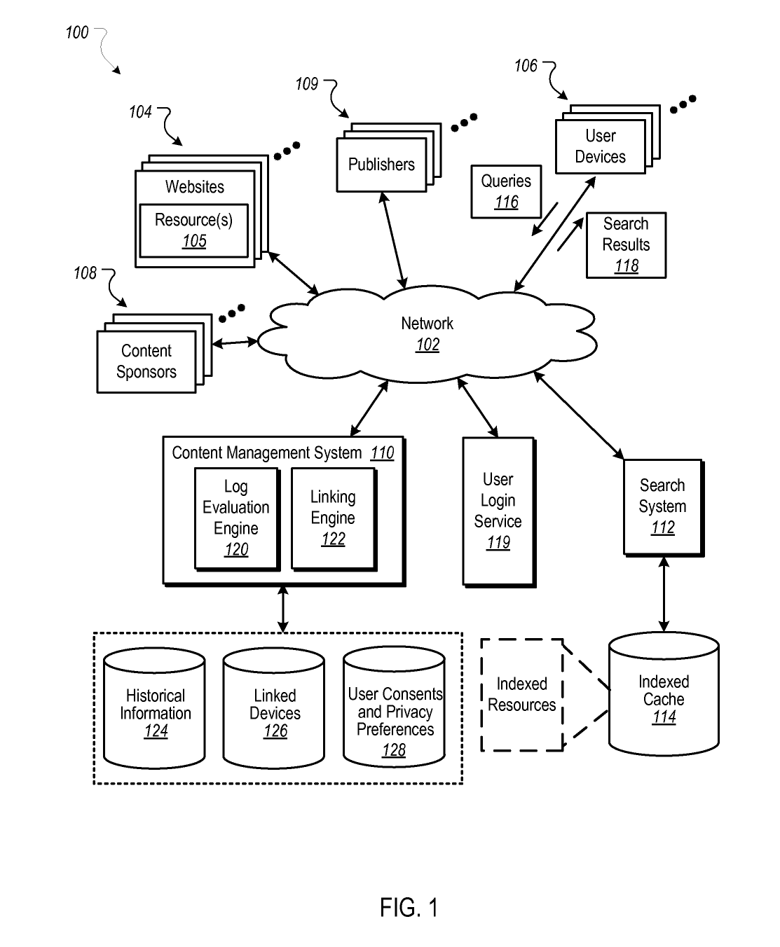

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

In some implementations, the example environment 100 further includes a user login service 119 that can provide, for any particular user, access to the user's Web services, e-mail, social networks, business applications or other resources. For example, the user login service 119 can include cloud-based user account management (CUAM) technology. In some implementations, the user login service 119 can receive login requests from the user, such as through a Web browser or other application running on a device associated with the user. The login request can include, for example, the user's login ID (e.g., a unique identifier, an email address, a phone number, or any other identifier for the user that can be used for verifying the user at login). The user login service 119 can also maintain information related to the devices on which the user is currently logged on, or has been logged into recently. The information can include, for example, a mapping of anonymous identifiers for the devices with, for example, a session key that does not contain personally identifiable information associated with the user. In some implementations, the mapping can be stored, for each user, in a data store of linked devices 126, or in some data structure.

A data store of historical information 124 can contain information about interactions associated with users that occurred while accessing content, such as impressions, clicks and interactions (e.g., conversions, web pages visited, and applications used). For example, the information can identify the user interactions on a per-device basis and per-user basis, e.g., for each of a user's different requesting sources, as identified by a device identifier. Entries in the historical information 124 can be linked to a particular user, for example, using information in the linked devices 126. Information about the number and scope of user interactions, for example, can be used to assess the quality of candidate advertisements that may be provided to the user. For example, based on the historical information 124 and the linked devices 126, an advertisement that is eligible to be provided to the user's device Z may be assigned a higher quality score because of the user's past interactions on devices X and Y. In some implementations, information stored in the historical information 124 can include identifiers (e.g., for requesting resources such as computing devices), user interactions, and one or more topics (e.g., sports, cameras, etc.) associated with the user interactions. Other information can also be stored.

A data store of user consents and privacy preferences 128 can include information that the user has provided regarding if and how information about the user's different devices can be used. For example, users can use one or more user preferences web pages that may be part of (or separate from) a user login service. In some implementations, users can set a preference that says, “Do not link my different devices,” or selectively identify which devices are allowed (or not allowed) to be linked. Then, before any operation is performed that may link the user's different devices, the user's consents and privacy preferences can be checked, and the linking will be performed only if allowed by the user. In some implementations, the user may specify settings that prohibit providing content based on the linking. For example, while the user may allow his smart phone and PC to be linked, the user may decide that no content (e.g., advertisements) should be provided based on the linking.

The content management system 110 can include plural engines. A log evaluation engine 120, for example, can evaluate the log entries, e.g., in the historical information 124. The evaluation can include identifying pairs of log entries that include a same user identifier and a same service identifier but different device identifiers. The evaluation can further include determining likelihoods that two given devices are associated with a user, and that the devices are not likely to be shared devices. A linking engine 122, for example, can link two or more devices (e.g., devices 106) and associate the linked devices with a particular user. Information regarding the linked devices and the associated user can be stored in the linked devices 126. For example, the linked information can include a user identifier, e.g., obfuscated in some way, and two or more anonymous device identifiers, such as anonymous identifiers that are determined from and stored in place of actual device identifiers (e.g., Device IDs, cookies, etc.). Further, an entry in the linked devices 126 can include more than one user identifier, as the same physical user may have multiple user identifiers that are associated with the user's various devices.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is responsive to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals. Other information, such as user identifier information that is associated with the mappings described above, can be used and/or evaluated when selecting eligible content.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable or observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by recognizing when a user is associated with multiple devices, and providing content based at least in part on that knowledge. For example, if it is known that a user is associated with device A (e.g., the user's home PC) and device B (e.g., the user's tablet computer of other device), and the devices A and B are linked, then historical information associated with the linked devices can be used to select content for delivery to the user. This can increase the likelihood of a conversion, for example, by either repeating impressions of an advertisement or avoiding subsequent impressions, depending on how multiple impressions for the advertisement to the same user are predicted to lead to a conversion in either case.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

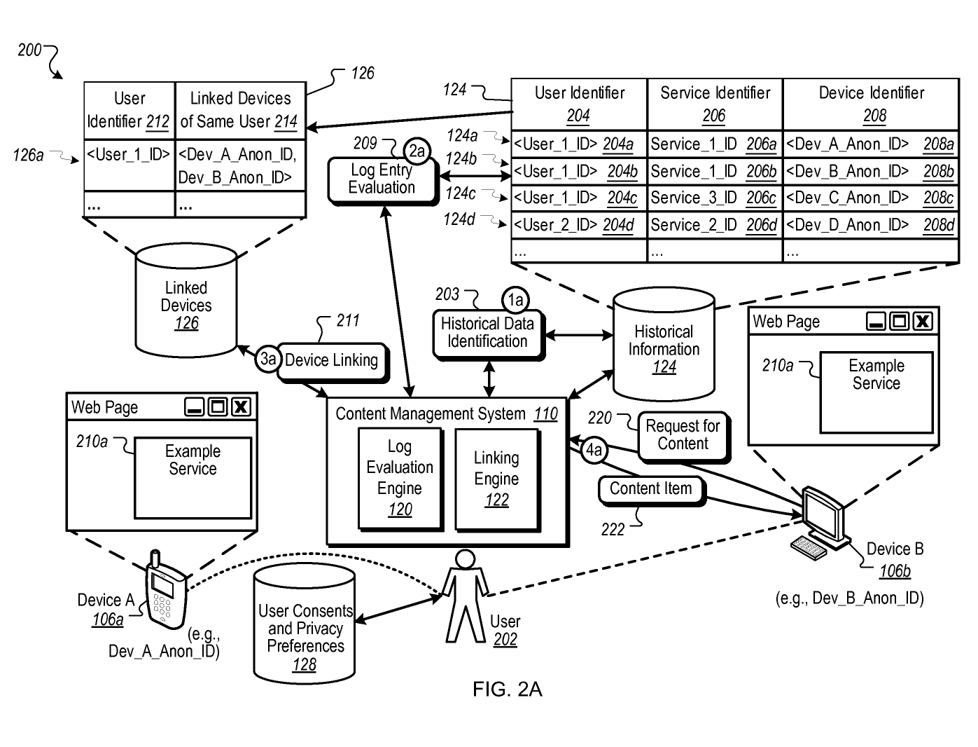

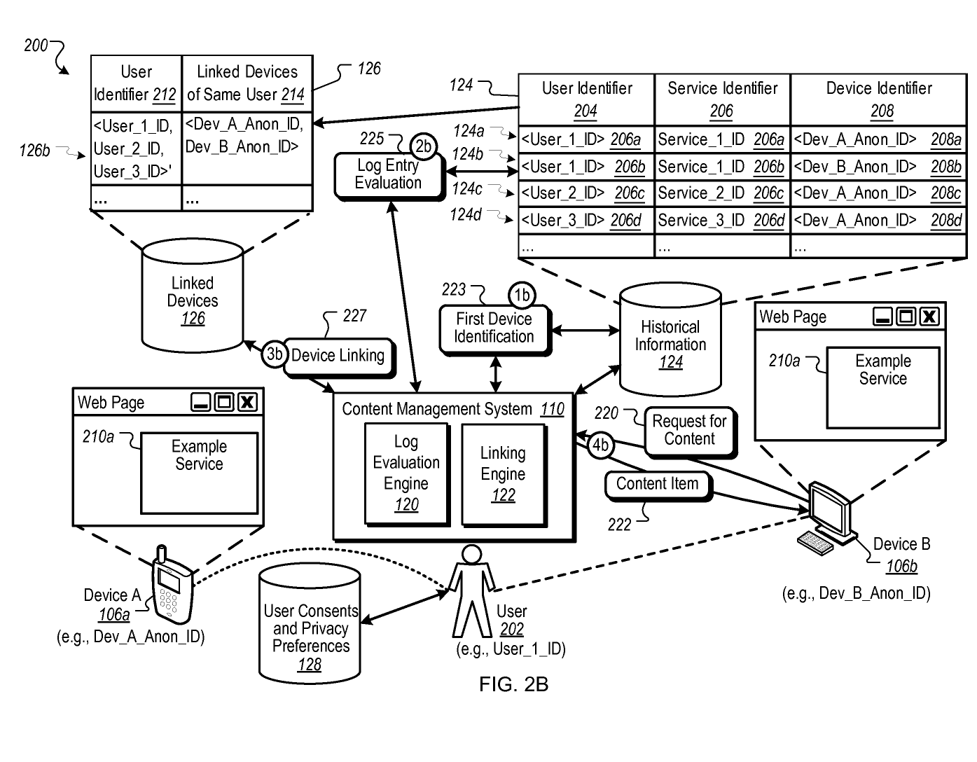

FIG. 2A shows an example sequence of events in a system 200 for selecting content based in part on linked devices associated with a user. For example, for a user 202, the linked devices can include a device A 106a (e.g., the user's mobile device), a device B 106b (e.g., the user's personal computer), and/or other devices that the user 202 may use. The system 200 can include several linked devices of multiple users and may include some or all of the components described with respect to the system 100 of FIG. 1.

At step 1a (e.g., historical information identification 203), the content management system 110, for example, can identify historical information 124 associated with user activity (e.g., user actions on the Internet). The historical information 124 can include a log of entries (e.g., entries 124a-124d) that can provide information about user activities collected over time. Each entry can include a user identifier 204 associated with a given user that accessed a service, a service identifier 206 associated with the service, and a device identifier 208 associated with a device used by the user for accessing the service. For example, each of plural user identifiers 204a-204d can be a hashed version of an actual user identifier (e.g., a user name, email, login ID, account number, etc.), or some other user identifier that is obfuscated in some way, e.g., to protect access to personally identifiable information. Service identifiers 206 (e.g., service identifiers 206a-206d) can correspond to specific resources, e.g., available on the Internet, such as online book stores, online auction sites, social networks, and/or any other online resources accessible to a user. For example, if the service is an online book store, the service identifier 206 may be the name of the store, the name of the domain (e.g., ExampleBookStore.com), the universal resource locater (URL) of a particular landing page, the name of a particular service accessible on an associated web page, and so on. Example device identifiers (e.g., device identifiers 208a-208d) can include an encrypted or obfuscated cookie identifier, device ID, or some other identifier of the device.

At step 2a (e.g., log entry evaluation 209), the log evaluation engine 120, for example, can evaluate the log entries, e.g., in the historical information 124. The evaluation can include identifying pairs of log entries that include a same user identifier and a same service identifier but different device identifiers. For example, the evaluation can identify a pair of entries 126a and 126b, both of which share the same user identifier (e.g., User_1_ID) and the same service identifier (e.g., Service_1_ID). However, the device identifiers in the pair of entries 126a and 126b may be different (e.g., Dev_A_Anon_ID and Dev_B_Anon_ID, respectively). The entries 126a and 126b may be present in the log, for example, as a result of the user 202 accessing the same service (e.g., example service 210a) on both device A 106a and device B 106b. The devices in this example have different device identifiers, e.g., Dev_A_Anon_ID and Dev_B_Anon_ID, respectively.

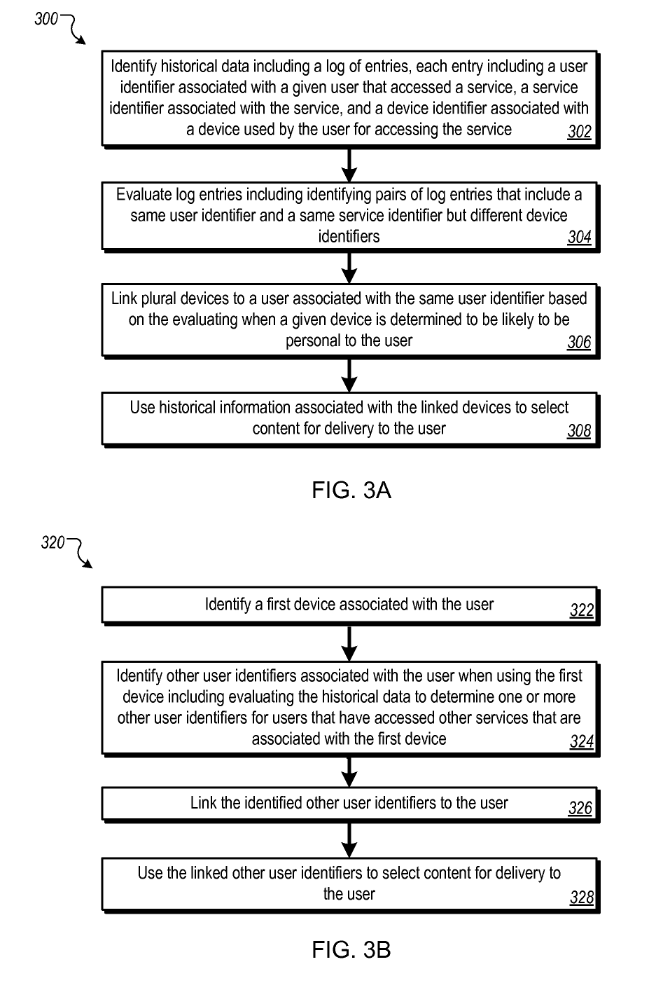

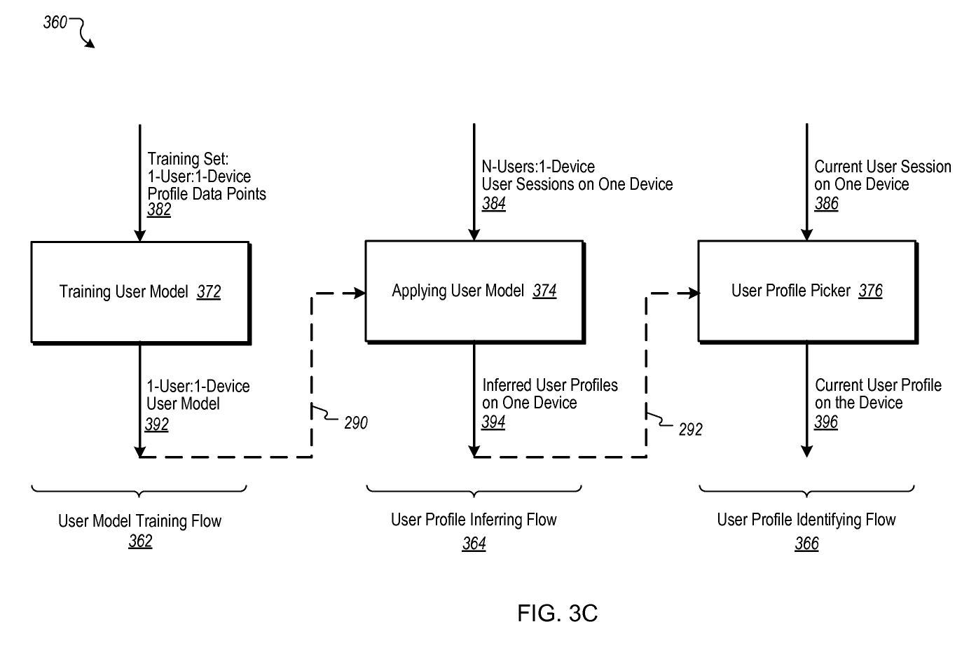

At step 3a (e.g., device linking 211), the linking engine 122, for example, can link the two devices 106a and 106b that have the device identifiers Dev A_Anon_ID and Dev_B_Anon_ID, respectively. For example, the linking information can be stored in an entry 126a in the linked devices 126. In the entry 126a, the two devices are linked to the same user 202, e.g., having user identifier User_1_ID. In some implementations, the linking engine 124 may perform the linking when, for example, the evaluating determines that a given device is likely to be personal to the user, and not shared. For example, the linking may not occur if there is a likelihood (e.g., over a predetermined threshold) chance that the device is a shared device, e.g., a computer at a public library, Internet café, school, or other location where multiple users are likely to use the same computer. In some implementations, the linking can be represented and/or stored using a user identifier 212 (e.g., User_1_ID) and some number of linked devices associated with the user identifier 212 (e.g., Dev_A_Anon_ID and Dev_B_Anon_ID). Methods for determining a likelihood that a device is shared are described in greater detail below and in association with FIG. 3c.

In some implementations, the linking can include determining a likelihood that the given device is personal to the user. As an example, a computer model can be used that is based on different types of indicators. One example indicator is a device type indicator (e.g., mobile versus non-mobile). The likelihood that a given device is personal to the user, for example, can be based on whether the device is mobile or non-mobile. For example, mobile devices (e.g., smart phones, cell phones, etc.) can be considered to be very likely to be personal to a specific user. Desktop computers, on the other hand, may be considered to be more likely to be shared among multiple users. In these examples, linking two devices may not occur unless the indicators are such that the linking is likely to involve non-shared devices associated with the same user.

Other indicators are possible. For example, an account activity indicator can be based on stored historical information that may include information determined by account management services, e.g., web sites that store information about accountholders. Stored information may include, for example, usernames, passwords, and other user information for users who have accessed third-party websites. One or more indicators based on user account activity can be used to determine if a pair of devices associated with the user should be linked. As an example, if the same username information (e.g., a specific account number) is received from two different devices (e.g., mobile and non-mobile), then the linking can proceed.

Another example indicator is associated with information about user habits, e.g., downloads, frequencies of user actions, time-of-day patterns of particular user actions, etc., that can be determined from a history of user interactions. In this example, certain patterns of user activity can be considered to be more (or less) likely to indicate that two devices belong to the same user.

Social network traffic is an example of another type of indicator. For example, if multiple ages and/or genders are associated with social network posts originating from the same device, then the device is likely to be a shared device. This can occur, for example, if several different people all use the same computer at a public library, Internet café, school, or other shared-device location.

In some implementations, the indicators can be used to determine different types of scores and/or probabilities. For example, a probability that a device is unique to a user, e.g., a 1-user:1-device relationship, can be higher if the device is mobile, e.g., assuming that a mobile device, such as a cell phone, is used by a single user. Another probability can be associated with a 1-user:M-devices relationship, e.g., the same user being mapped to multiple devices. Another probability can be associated with an N-users:1-device relationship, e.g., multiple users being mapped to the same device. For example, a probability can be associated with determining a likelihood that a given device is shared by plural users. These and other probabilities can be used to determine, for example, whether linking any two devices associated with a user should occur.

In some implementations, determining the likelihood that the given device is personal to the user can include evaluating activities associated with the given device using the historical data, e.g., historical information 124. For example, the historical entries may provide an indication, based on user interactions corresponding to a given device, that the given device is likely to be unique to a user, and not shared, or the other way around. For example, determining the likelihood that a device is unique to a user can include identifying a threshold (e.g., 90% probability) and determining if the likelihood exceeds the identified threshold. For a mobile device, it may be determined (e.g., at a 95% likelihood) that the device is unique to a single user, and in this case the likelihood would exceed the threshold (e.g., 90% probability), and linking of that device to other devices for the user would occur.

At step 4a, information in the linked devices 126 (e.g., historical information associated with the linked devices A 106a and B 106b) is used to select content (e.g., advertisements) for delivery to the user 202. For example, in response to a request for content 220 received from the device B 106b, the content management system 110 can provide a content item 222 (e.g., an advertisement) based at least in part on information in the linked devices 126.

FIG. 2B shows an example sequence of events in the system 200 for linking and selecting content for additional devices associated with the user. For example, a given user may have different user identifiers associated with the use of different services, such as an account number associated with an online bookstore and a username associated with an online auction. Another difference in the identifiers can exist, for example, due to a different spelling variant of the user's name (e.g., Andy vs. Andrew) and/or the inclusion of a middle name or initial. These different user identifiers can appear as different user identifiers 204 in the historical information 124, even though they are associated with the same user. By examining the associated device identifiers 208 of the corresponding entries, the user identifiers can be linked even though service identifiers 206 in the entries may be different.

At step 1b (e.g., first device identification 223), the content management system 110, for example, can identify a first device associated with the user 202, e.g., device A 106a having a device identifier of Dev_A_Anon_ID. The identification can be made, for example, when content is to be provided to a user associated with the first device.

At step 2b (e.g., log entry evaluation 225), the log evaluation engine 120, for example, can identify other user identifiers associated with the user 202. For example, the user identifiers 204 that are identified can include the user identifiers associated with users using the first device (e.g., device A 106a), including evaluating the historical data 124 to determine one or more other user identifiers for users that have accessed other services that are associated with the first device. As an example, the log evaluation engine 120 can identify entries in the historical information 124 that have Dev_A_Anon_ID as the device identifier 208, and determine user identifiers 206 of User_2_ID and User_3_ID in entries 124c and 124d, respectively.

At step 3b (e.g., device linking 227), the linking engine 122, for example, can link the identified other user identifiers to the user. For example, the linking can include linking User_1_ID to both User_2_ID and User_3_ID, as shown in the entry 126b. In this example, the linked information includes the user identifiers User_1_ID, User_2_ID, and User_3_ID (all associated with the same physical user) and the device identifiers Dev_A_Anon_ID and Dev B_Anon_ID.

At step 4b, information in the linked devices 126 is used to select content for delivery to the user 202. For example, in response to the request for content 220 received from the device B 106b, the content management system 110 can provide the content item 222 based at least in part on information in the linked devices 126. In this example, the delivery of content can be influenced by the linking that exists between device A 106a and device B 106, as well as the three user identifiers that are linked in association with device A 106a. Content selection can be based, for example, on user interests or other selection criteria that can be used to select content for the other user identifiers. Alternatively or subsequently, the request for content 220 can be received from the device A 106a, and the content management system 110 can provide a content item 222 based at least in part on information in the linked devices 126.

FIG. 3A is a flowchart of an example process 300 for selecting content based at least in part on devices linked using historical data that includes user access of specific services from specific devices. In some implementations, the content management system 110 and its components can perform steps of the process 300 using instructions that are executed by one or more processors. FIGS. 1 and 2A are referenced as example structures/interfaces associated with the steps of the process 300. As described above, using linked devices associated with a user to select content may occur when permitted by the user, e.g., based on settings in the user consents and privacy preferences 128.

Historical data is identified, including a log of entries (302). As described above, each entry includes a user identifier associated with a given user that accessed a service, a service identifier associated with the service, and a device identifier associated with a device used by the user for accessing the service. For example, information about user interactions can be recorded over time in the historical information 124 and accessed as needed by the content management system 110, e.g., to link devices.

In some implementations, historical information can be gathered and stored by a supervisor process or some other mechanism. For example, the process 300 can further include gathering information about how the user accesses services, including storing, in a log of historical data (e.g., historical information 124), user accesses along with access device data. In some implementations, gathering information can further include monitoring user interactions with services as part of an access control process, a password service, a user login service, or some other service. In some implementations, the access control process and/or other services can execute in a cloud computing environment.

Log entries are evaluated, including identifying pairs of log entries that include a same user identifier and a same service identifier but different device identifiers (304). For example, the log evaluation engine 120 can evaluate log entries in the historical information 124. The evaluation can include identifying pairs of log entries that include a same user identifier and a same service identifier but different device identifiers. For example, the evaluation can identify a pair of entries 126a and 126b, both of which share the same user identifier (e.g., User_1_ID) and the same service identifier (e.g., Service_1_ID). However, the device identifiers in the pair of entries 126a and 126b may be different (e.g., Dev_A_Anon_ID and Dev_B_Anon_ID, respectively). The entries 126a and 126b may be present in the log, for example, as a result of the user 202 accessing the same service (e.g., example service 210a) on both device A 106a and device B 106b. The devices in this example have different device identifiers, e.g., Dev_A_Anon_ID and Dev_B_Anon_ID, respectively.

Plural devices are linked to a user associated with the same user identifier based on the evaluating when a given device is determined to be likely to be personal to the user (306). For example, device A 106a and device B 106b can be linked to the user 202. This can occur, for example, when the linking engine 112 links the device identifiers associated with the two devices, and stores the information in the linked devices 126. For example, entry 126a can link device identifiers Dev_A_Anon_ID and Dev_B_Anon_ID in association with the user identifier User_1_ID.

Historical information associated with the linked devices is used to select content for delivery to the user (308). For example, in response to the request for content 220, the content management systems 110 can provide the content item 222 (e.g., an advertisement). Selection of the particular content item 222 can be based on, for example, user interests and/or other selection criteria associated with content provided to the user on any of the linked devices.

FIG. 3B is a flowchart of an example process 320 for selecting content based at least in part on additional user identifiers associated with the user. For example, the steps in the process 320 can be performed after historical data is identified, log entries are evaluated, and plural devices are linked to a user, as described above in the process 300 (FIG. 3A). In some implementations, the content management system 110 and its components can perform steps of the process 320 using instructions that are executed by one or more processors. FIGS. 1 and 2B are referenced as example structures/interfaces associated with the steps of the process 320. As described above, using linked devices associated with a user to select content may occur when permitted by the user, e.g., based on settings in the user consents and privacy preferences 128.

A first device associated with the user is identified (322). For example, the content management system 110 can identify device A 106a having the device identifier Dev A_Anon_ID.

A determination can be made as to whether the first device is personal to the user or shared. Assuming the device is personal, other user identifiers are identified that are associated with the user when using the first device, including evaluating the historical data to determine one or more other user identifiers for users that have accessed other services that are associated with the first device (324). As an example, the log evaluation engine 120 can identify other user identifiers associated with the user 202, including identifying entries 124c and 124d in the historical information 124 that have Dev A_Anon_ID as the device identifier 208. Once those entries are identified, the log evaluation engine 120 can determine user identifiers 206 of User_2_ID and User_3_ID from entries 124a, 124c and 124d, respectively. These are the other user identifiers that are identified as being associated with user 202 when using device A 106a.

The identified other user identifiers are linked to the user (326). For example, the linking engine 122 can link the identified other user identifiers to the user. As a result, the linking can include linking User_1_ID to both User_2_ID and User_3_ID, as shown in the entry 126b. In this example, the linked information includes the user identifiers User_1_ID, User_2_ID, and User_3_ID (all associated with the same physical user) and the device identifiers Dev A_Anon_ID and Dev B_Anon_ID.

The linked other user identifiers are used to select content for delivery to the user (328). For example, in response to the request for content 220 received from the device B 106b, the content management system 110 can provide the content item 222 based at least in part on information in the linked devices 126. The delivery of content in this example can be influenced by the linking that exists between device A 106a and device B 106b, as well as the three user identifiers that are linked in association with device A 106a. Content selection can be based, for example, on user interests or other selection criteria that can be used to select content for the other user identifiers.

FIG. 3C shows an example system 360 for modeling multiple users on one device. For example, the system 360 can be used in determining situations in which multiple users are likely to be using a shared device. The system 360 can be used, for example, to map N users on a single device in an N-users:1-device mapping. The mapping can be based on user profiles, one each for the N users using the device.

The system 360 include three flows 362-366: a user model training flow 362 for training a user model 372, a user profile inferring flow 364 for applying the user model 374, and a user profile identifying flow 366 for using a user profile picker 376 to select a user profile that applies to a current session. One of the functions of the system 360 is to select a user profile, e.g., from among N user profiles of multiple users using the same device. Moreover, the process of using the flows 362-264 can result in identifying when multiple users are associated with a single device.

In the user model training flow 362, training the user profile model 372 can use 1-user:1-device data points 382, e.g., excluding any existing N-users:1-device data points from the training set. The data points used, then, include information about user actions when using the device. N-users:1-device data points can be detected in various ways. For example, if two or more high-quality user profile raw data sources strongly disagree on the user profile for a device, it can be a good indicator that this device is used by multiple users. The system 360 can determine that multiple users are using a shared device, or at least a likelihood that this is the case (which can be provided as an input to the methods discussed above with reference to FIGS. 3A and 3B). An output of the user model training flow 362 is a 1-user:1-device user model 392, e.g., creating one user model per user, per device.

In the user profile inferring flow 364, applying the user profile model 374 can infer user profiles on a device based on historical user activity sessions on the device 384. There can be more than one user profile inferred by the model for one device. For example, using the 1-user:1-device user model 392 can result in inferring N-users:1-device profiles 394 on each individual device.

In the user profile identifying flow 366, when detecting a user profile based on the current session 386 on a device (e.g., for selecting content to provide to a user), a user profile picker 376 can be used to identify a profile 396 of the current user who is using the device. The user profile picker 376 can be implemented in various ways. In some implementations, the user profile picker 376 can be based on user activity matching. This approach can try to match the current user activity with user activities associated with one of the N user profiles associated with the device. For example, the method can include picking the best-matching profile for the user currently using the device. If the matching does not succeed, other means can be used to pick the current user profile. For example, the matching algorithm is outlined in the following steps, where act_curr represents the current session's user activities and act_prof_i represents the user activity sets associated with different user profiles on the device.

In step 1, an attempt is made to match act_curr with act_prof_i, for every user profile i. The best matching user profile can be selected as the current user profile.

In step 2, if step 1 does not succeed in identifying and selecting the current user profile, then the act_curr is used as an input 290 of the 1-user:1-device user model, e.g., to attempt to have the user model generate the inferred user profile. The selected user profile is the user profile on the device that best matches the inferred user profile as the current user profile.

In step 3, if step 2 does not succeed in identifying and selecting the current user profile, the inferred user profiles 394 are used as an input 292 to step 3, and the most-frequent user profile on the device is picked as the current user profile.

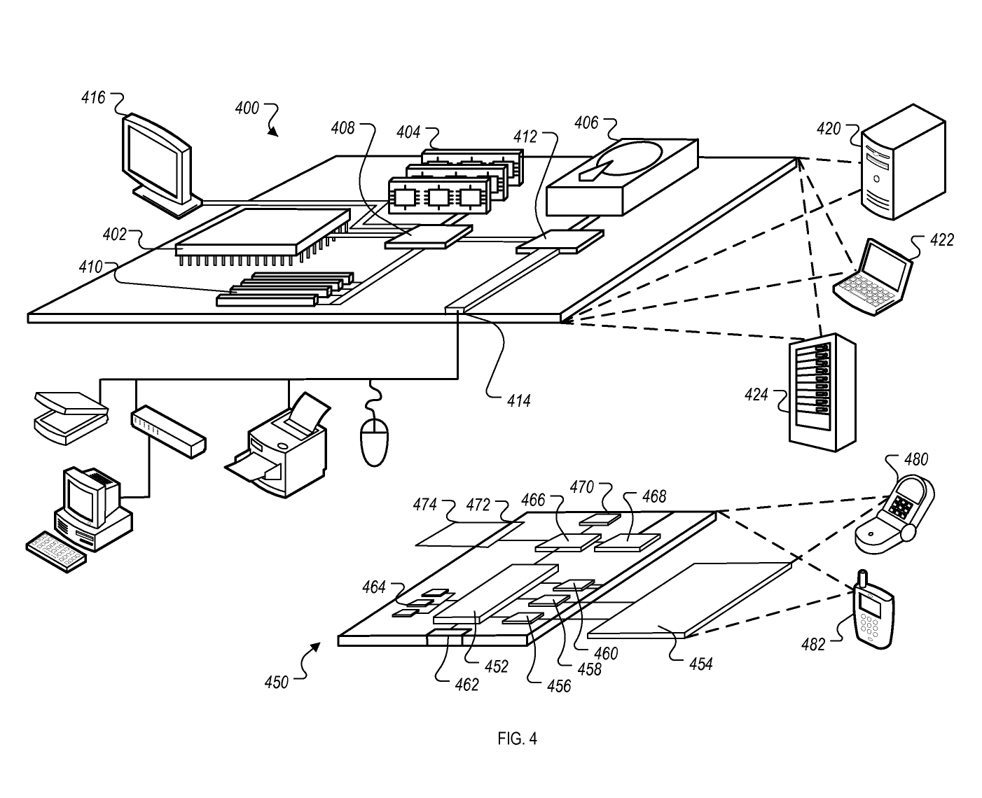

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a subscriber identification module (SIM) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying historical data including a log of entries, each entry including a user identifier associated with a given user that accessed a service, a service identifier associated with the service, and a device identifier associated with a device used by the user for accessing the service;
evaluating log entries including identifying pairs of log entries that include a same user identifier and a same service identifier but different device identifiers;
linking plural devices to a user associated with the same user identifier based on the evaluating when a given device is determined to be likely to be personal to the user; and
using historical information associated with the linked devices to select content for delivery to the user.

2. The method of claim 1 further comprising:
identifying a first device associated with the user;
identifying other user identifiers associated with the user when using the first device including evaluating the historical data to determine one or more other user identifiers for users that have accessed other services that are associated with the first device;
linking the identified other user identifiers to the user; and
using the linked other user identifiers to select content for delivery to the user.

3. The method of claim 1 wherein linking includes determining a likelihood that the given device is personal to the user.

4. The method of claim 3 wherein determining a likelihood includes determining a likelihood that the given device is shared by plural users.

5. The method of claim 4 wherein determining a likelihood includes evaluating activities associated with the given device using the historical data.

6. The method of claim 5 wherein determining a likelihood includes identifying a threshold and determining if the likelihood exceeds the identified threshold.

7. The method of claim 1 further comprising gathering information about how the user accesses services including storing, in a log of historical data, user accesses along with access device data.

8. The method of claim 7 wherein gathering information further includes monitoring user interactions with services as part of an access control process.

9. The method of claim 8 wherein the access control process executes in a cloud computing environment.

10. The method of claim 1 wherein using the historical information associated with linked devices further includes using the historical information to select advertisements for delivery to the user.

11. A computer program product embodied in a tangible medium including instructions, that when executed, cause a processor to:
identify historical data including a log of entries, each entry including a user identifier associated with a given user that accessed a service, a service identifier associated with the service, and a device identifier associated with a device used by the user for accessing the service;
evaluate log entries including identifying pairs of log entries that include a same user identifier and a same service identifier but different device identifiers;
link plural devices to a user associated with the same user identifier based on the evaluating when a given device is determined to be likely to be personal to the user; and
use historical information associated with the linked devices to select content for delivery to the user.

12. A system comprising:
a processor; and
a memory including instructions that when executed cause the processor to:
identify historical data including a log of entries, each entry including a user identifier associated with a given user that accessed a service, a service identifier associated with the service, and a device identifier associated with a device used by the user for accessing the service;
evaluate log entries including identifying pairs of log entries that include a same user identifier and a same service identifier but different device identifiers;
link plural devices to a user associated with the same user identifier based on the evaluating when a given device is determined to be likely to be personal to the user; and
use historical information associated with the linked devices to select content for delivery to the user
